(19) United States
(12) Patent Application Publication
(10) Pub. No.: US 2009/0317769 A1
(43) Pub. Date: Dec. 24, 2009

(54) RESILIENT COPING FOR IMMEDIATE LOADING OF DENTAL IMPLANTS

(76) Inventor: Rainier A. Urdaneta, Auburndale, MA (US)

Correspondence Address: DAY PITNEY LLP, 7 TIMES SQUARE, NEW YORK, NY, 10036-7311, US

(21) Appl. No.: 12/312,476

(22) PCT Filed: Nov. 14, 2007
(86) PCT No.: PCT/US07/23926

§ 371 Date: May 12, 2009

Related U.S. Application Data
(60) Provisional application No. 60/858,693, filed on Nov. 14, 2006.

(51) Int. Cl. A61C 13/09

(52) U.S. Cl. 433/202.1

(57) ABSTRACT

A resilient coping for use in the immediate loading of a newly placed dental implant with a temporary tooth has a resilient liner to prevent movement of the temporary tooth mounted on the resilient coping from being transmitted to the implant, thereby promoting its osseointegration.

### BACKGROUND OF THE INVENTION

1. Field of the Invention

The present invention relates generally to restorative dentistry and more particularly to dental implant prosthetic procedures and apparatus used therewith. More particularly still, the present invention relates to the immediate loading and stabilization of newly implanted single implants.

2. Description of the Prior Art

Primary stability is considered to be a prerequisite for the immediate loading and stabilization of newly implanted single implants. The splinting (or connection) of a newly placed implant to adjacent teeth is a common technique to provide such stabilization.

However, it is well known that teeth exhibit normal physiologic movements in vertical, horizontal, and rotational directions during biting and chewing. For example, vertical tooth movement has been measured to be 28 microns (0.028 mm), while horizontal tooth movement may be as high as 108 microns (0.108 mm), particularly in teeth located at the front of the mouth. While these movements are indeed quite small, they generally exceed the corresponding movements observed for fully implanted teeth. For example, vertical movement of a rigid implant has been measured to be in a range from 2 to 3 microns (0.002 mm to 0.003 mm). Horizontal movement of a rigid implant is also generally less than that observed in natural teeth.

More importantly, horizontal and vertical tooth movement in teeth splinted to a newly placed implant can interfere with the osseointegration of the implant. That is to say, the natural movements of the connected natural teeth can interfere with the integration of the implant with the bone of the maxilla or mandible, because they can interfere with local bone healing and predispose to a fibrous tissue interface instead of osseointegration. A threshold of about 100 microns (0.1 mm) of micromotion can be tolerated before a fibrous tissue interface, instead of an osseointegrated interface, develops around an implant. Since natural tooth movement can approach this threshold, a mechanism for preventing this movement from being transmitted from the natural teeth to the implant is desirable. Such a mechanism is provided by the present invention.

### SUMMARY OF THE INVENTION

An object of the present invention is to provide for the immediate stabilization of implants in cases where primary bone stability has not been achieved. Another object is to provide faster bone healing and increased patient comfort associated with achieving immediate function. Still another object is to provide a device to be used on single implants or interim copings for compensating for the dissimilar degree of mobility that occurs between teeth and implants.

Briefly, in accordance with a preferred embodiment of the present invention, when an implant is first placed, it is connected to supporting teeth by means of a temporary coping. Resilient material is used to compensate for the difference in movement between teeth and implants. The resilient material used has a degree of resiliency which enables it to allow at least 100 microns (0.100 mm) of mobility in a horizontal plane, and at least 25 microns (0.025 mm) of mobility in a vertical plane, without transmitting motion to the implant.

Accordingly, the present invention is a resilient coping for use in the immediate loading of a newly placed implant with a temporary tooth. The resilient coping is designed for placement over a head portion of an abutment which is to be disposed in the dental implant. The resilient coping takes the form of a sleeve and includes a coping of a relatively non-resilient material. The coping has the general form of a sleeve having an internal tapered passage with a narrow end and a wide end and a base at the wide end.

The resilient coping has a resilient liner in the internal tapered passage. The resilient liner extends onto the base and forms a resilient cushion thereon to separate the base of the coping from the abutment. The resilient liner is of a material having a greater degree of resiliency than that of the coping.

The present invention will now be described in more complete detail with frequent reference being made to the figures identified below.

### BRIEF DESCRIPTION OF THE DRAWINGS

FIG. 1 is a side elevational view of an abutment;

FIG. 2 is a side elevational view of the abutment of FIG. 1 having a resilient coping disposed thereon;

FIG. 3 is a side elevational view, like that of FIG. 2, wherein the resilient coping appears in cross section; and

FIG. 4 is a view, partly in cross section, of a dental implant on which the present invention may be applied.

### DETAILED DESCRIPTION OF THE PREFERRED EMBODIMENT

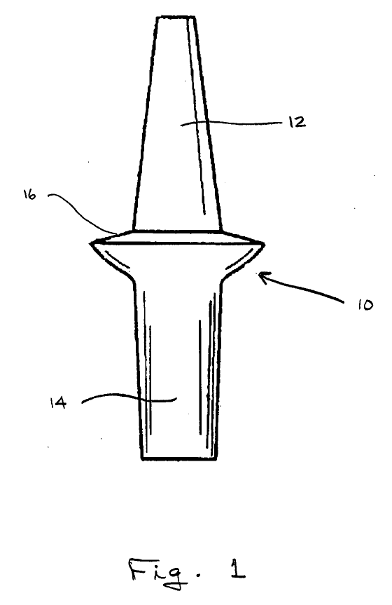

Turning now more specifically to these figures, FIG. 1 is a side elevational view of an abutment with which the present invention may be practiced. The abutment 10, which is of the variety disclosed in U.S. Pat. No. 6,290,500 to Morgan et al., the teachings of which are incorporated herein by reference, has a head portion 12 and a post 14. The latter has a self-holding taper of less than 5°, so that, with an appropriate amount of tapping with a surgical mallet, it may be secured within an implant. The abutment 10 also has a shelf 16 which is inclined at an angle relative to an imaginary plane perpendicular to be longitudinal axis of the head portion 12. The angle may be in a range from approximately 0° to 30°, and is more preferably approximately 15°.

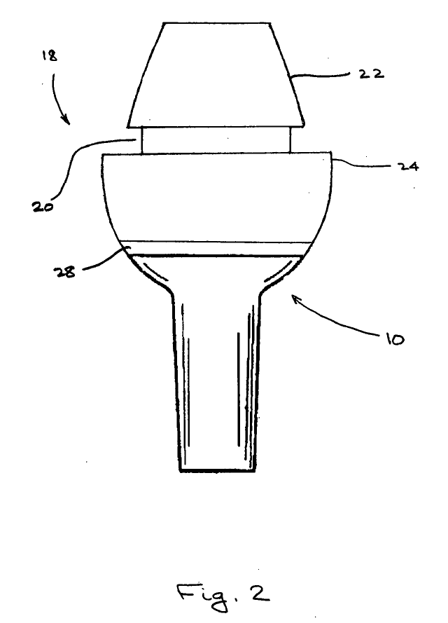

FIG. 2 is a side elevational view of the abutment 10 having an interim coping 18 disposed over head portion 12. Interim coping 18 is similar to that shown in U.S. Pat. No. 5,749,731 to Morgan et al., the teachings of which are incorporated herein by reference. The interim coping 18 has a generally annular groove 20 forming a radially extending flange 22 which has an outer diameter reduced somewhat relative to the other side 24 of groove 20 in order to allow a temporary tooth to be formed over flange 22 with the outer surface of the tooth forming a continuous smooth surface with the coping 18, and with the groove 20 allowing for a mechanical connection between the coping and the temporary tooth material.

It is known that acrylic, which is used for conventional interim copings, has some shock-absorbing properties, but the use of acrylic can result in unacceptable transmission of movement to a newly placed implant. In accordance with a preferred embodiment of the present invention, a conventional interim coping, such as a one-piece acrylic sleeve, is lined with a resilient lining material.

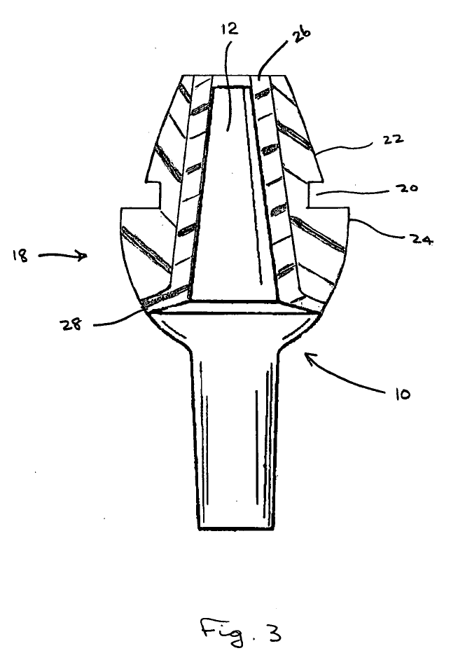

Turning to FIG. 3, a view similar to that of FIG. 2 except that interim coping 18 is shown in cross section, interim coping 18 essentially takes the form of a sleeve which fits over the head portion 12 of the abutment 10. The interim coping 18 has a resilient liner 26 having a thickness of approximately 1.0 mm or less. Resilient liner 26 also forms a resilient cushion 28 between the interim coping 18 and shelf 16 of the abutment 10. Resilient liner 26, which has a higher degree of resiliency than acrylic, amplifies the shielding effect of the acrylic, and helps to compensate for the dissimilar degree of movement between teeth and implants.

The resilient lining material used to form resilient liner 26 may be a plasticized acrylic resin, such as that sold under the name PermaSoft® by DENTSPLY Austenal of DENTSPLY International Inc. of York, Pa. PermaSoft® is a two-component (powder and liquid) plasticized methacrylate indicated for use in stabilizing and relining complete and partial dentures. The compliance and resiliency of PermaSoft® can be varied by altering the powder/liquid ratio in accordance with its directions for use. The powder principally comprises poly(methylmethacrylate) or poly(ethylmethacrylate) as principal structural components. The liquid (the plasticizer) includes dibutyl phthalate. The so-called “firm” density material, made with a powder/liquid ratio of 3:1, is used as the resilient liner 26.

Alternatively, a silicone-based material, such as SOFRELINER® MS/S, a silicone-based chairside soft denture reline material, may be used to make resilient liner 26. SOFRELNER® MS/S, a silicone rubber material, is available from Tokuyama America Inc. of Encinitas, Calif.

In accordance with the present invention, the internal surface of a conventional interim coping is reduced by approximately 1.0 mm to provide space for the resilient lining material. Where the lining material is PermaSoft®, it is mixed according to the manufacturer's recommendations in their directions for use using a powder/liquid ratio of 3:1 and placed into the inside of the adjusted coping. An abutment of similar size is inserted into the modified coping and the lining material is allowed to polymerize in hot water inside a pressure pot (20 psi/1.4 bar) for 15 minutes, also in accordance with the manufacturer's directions for use. The excess material is removed with a scalpel, the coping may be shortened to a length like that shown in FIGS. 2 and 3, if it is not of desired length, and groove 20 is added, if necessary, to enable a temporary tooth to be firmly attached thereto.

More particularly, a conventional one-piece acrylic sleeve (coping) suitable for use with a selected implant abutment (perhaps 4.0 mm in width, but it will be appreciated that the particular size is a matter of choice) is modified by removing approximately 1.0 mm of the inside surface of the sleeve in order to provide space for the resilient liner. The resilient liner material is placed inside the adjusted coping essentially in the same thickness as the removed acrylic material. The sleeve, formed with the resilient liner, is placed onto a matching 4.0-mm-wide abutment, such as a stealth shouldered abutment sold under the name BICON DENTAL IMPLANTS® by Debbie, LLC of Boston, Mass. The sleeve is not completely seated so that resilient material remains between the acrylic sleeve (coping) and the abutment at the end face of the sleeve as well as on its inside wall. The acrylic sleeve (coping) is shortened and a groove is formed about the periphery of the sleeve to add retention and resistance for use for attaching the sleeve to temporary material used by a dentist for making a temporary tooth. The sleeve (coping) is polished to remove any sharp edges, and is then ready for use by a dentist. Alternatively, the resilient coping may be removed from the abutment on which it was produced for later use, as neither plasticized resin nor silicone bond or adhere to the metal of the abutment. A separating medium may be used on the abutment if desired to facilitate removal.

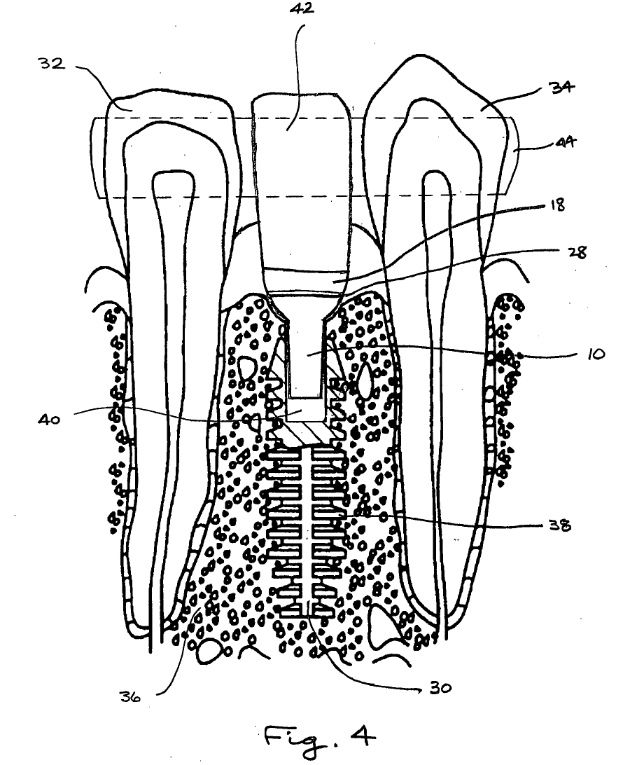

FIG. 4 is a view, partly in cross section, of an implant 30 to which the present invention may be applied. Implant 30 is disposed in an osteotomy site in the jaw of a patient between two natural teeth 32, 34. Implant 30 is installed in bone tissue 36 in a hole of appropriate diameter drilled by a surgeon. During the healing process, in which minimal movement of the implant 30 is desired, the implant 30 becomes secured in the bone tissue 36 through osseointegration, wherein bone tissue 36 regenerates and forms between the fins 38 running longitudinally along the implant 30 to firmly root the implant 30 in the bone tissue 36.

Implant 30 has a well 40 into which abutment 10 with interim coping 18, as shown in FIG. 3, is disposed and locked in place by tapping with sufficient force and to a sufficient extent to remain in place during the healing process, but to be easily removed at the conclusion of that process for replacement with a permanent tooth. Referring back to FIG. 4, interim coping 18 and resilient cushion 28 are shown between abutment 10 and temporary tooth 42, which is fashioned by the dentist from a light- or chemically-curable resin on interim coping 18 where groove 20, visible in FIGS. 2 and 3, assists in anchoring the resin on the interim coping 18 through a mechanical connection that forms therebetween.

Also shown in FIG. 4, although on the far side of the teeth 32, 34, 42, is a splint 44, also fashioned by the dentist from light- or chemically-curable resin, and bonded to teeth 32, 34, 42. Splint 44 anchors temporary tooth 42 to the natural teeth 32, 34 on each side to limit the amount by which temporary tooth 42 may shift to that by which the natural teeth may shift. Resilient sleeve 26 and resilient cushion 28 prevent the transmission of that movement to the implant 30 during the healing process so that its osseointegration may be successfully achieved.

Fabrication of an interim restoration, temporary tooth 42 and splinting to adjacent teeth will now be described more fully. The resilient coping, which comprises the interim coping 18, resilient liner 26 and resilient cushion 28, is used as part of the temporary tooth 42, as mentioned above. The part that will be in contact with the implant abutment has the capability of cushioning the impact of the biting force. Conventional bonding techniques are used to prepare the adjacent teeth, natural teeth 32, 34, for bonding, namely, etching of the enamel, using primer and adhesive, and then light-curing the adhesive. Splint 42 is fabricated with resin on the lingual sides of the teeth and interim coping, and the resin, which starts as a paste and hardens when exposed to light of a specific nature, is light-cured. The resin is then applied to the facial area of the interim coping until proper anatomical contours are achieved, shaping the resin to resemble a tooth. The bite is then adjusted as necessary.

Thus, in accordance with a preferred embodiment of the present invention, an acrylic sleeve, or coping, having a selected degree of resiliency, greater than that of acrylic itself, is provided with a lining that engages the abutment for the immediate loading of dental implants. The modified coping is splinted to adjacent stable teeth. Thus, when the patient bites down and the teeth move, the resilient coping prevents the movement from being transmitted to the implant, thereby allowing the implant to integrate.

Although the present invention has been described with regard to a specific preferred embodiment thereof, variations and modification will become apparent to those of ordinary skill in the art. For example, it is within the purview of the present invention to provide a coping formed of a resin that is able to cushion or deflect at least 100 microns of movement. That is, the entire coping could be formed of a resin having a sufficient resiliency so that, depending on the mobility of adjacent teeth, when the temporary tooth moves an amount in a range from approximately 100 microns (0.100 mm) to 300 microns (0.300 mm), the implant will not move.

It is the intention of the inventor that the appended claims be given as broad an interpretation as possible view of the prior art to include all such variations and modifications.

Modifications to the above would be obvious to those of ordinary skill in the art but would not bring the invention so modified beyond the scope of the appended claims.

What is claimed is:

1. A resilient coping for use in the immediate loading of a newly placed dental implant with a temporary tooth, said resilient coping being designed for placement over a head portion of an abutment to be disposed in said dental implant and taking the form of a sleeve, said resilient coping comprising:
a coping, said coping having the general form of a sleeve having an internal tapered passage with a narrow end and a wide end and a base at said wide end; and
a resilient liner on said internal tapered passage, said resilient liner extending onto said base and forming a resilient cushion on said base to separate said coping from said abutment, said resilient liner being of a material having a greater degree of resiliency than said coping.

2. A resilient coping as claimed in claim 1 wherein said coping is of a first polymeric material.

3. A resilient coping as claimed in claim 2 wherein said first polymeric material is an acrylic material.

4. A resilient coping as claimed in claim 1 wherein said resilient liner is of a second polymeric material.

5. A resilient coping as claimed in claim 4 wherein said second polymeric material is a plasticized methacrylate resin.

6. A resilient coping as claimed in claim 4 wherein said second polymeric material is a silicone rubber material.
